(19) United States
(12) Patent Application Publication
(10) Pub. No.: US 2002/0167733 A1
(43) Pub. Date: Nov. 14, 2002

(54) Compact display device

(76) Inventor: Wouter Roest, Eindhoven (NL)

Correspondence Address: U.S. Philips Corporation, 580 White Plains Road, Tarrytown, NY, 10591, US

(21) Appl. No.: 10/134,208

(22) Filed: Apr. 26, 2002

(30) Foreign Application Priority Data
Apr. 27, 2001 (EP) 01201571.5

(51) Int. Cl. G02B 27/10; G02B 27/14

(52) U.S. Cl. 359/625; 359/629; 359/626; 359/628

(57) ABSTRACT

The invention relates to a compact display device that can be used in small personal devices, such as head-mounted displays, mobile phones and personal digital assistants (PDA). The display device is provided with a light source and a reflective display for forming an object image, and an optical system for projecting a virtual image of the object image. In order to improve the illumination of the reflective display, the display device is provided with a light-guiding means for substantially perpendicular illumination of the reflective display via total reflection.

The invention relates to a display device as defined in the precharacterizing part of claim 1.

Compact display devices are used in head-mounted displays and small personal devices such as personal digital assistants, mobile telephones and WAP telephones.

A compact display is known from U.S. Pat. No. 5,892,624. The known display system comprises on optical system having a prism with an immersed beam splitter and a mirror element, a reflective liquid crystal display to form an object source, and a light source to illuminate the reflective liquid crystal display. In operation, the light source illuminates the reflective liquid crystal display via the prism. The reflective liquid crystal display modulates the light rays and reflects the radiation to the mirror element via reflection of the beam-splitting surface. The mirror element images the source object to a viewer via the beam-splitting surface in the prism.

In this display device, a specular reflective LCD can be applied, for example, a liquid crystal on silicon (LCOS) display panel. However, the maximal obtainable contrast is limited in that case.

It is an object of the invention to provide a compact display system having an improved contrast. This object is achieved by a display system in accordance with the invention as defined in claim 1. The invention is based on the insight that the contrast of a specular reflective display is maximized when the illumination is substantially perpendicular to the plane of the reflective display panel. In the known display device, this may give rise to problems because the illumination means will appear in the imaging path of the optical system. In the display system in accordance with the invention, the illumination can be directed perpendicular to the plane of the display device via one or more total internal reflections in the light-guiding means without disturbing the image path.

A particular embodiment of the device in accordance with the invention is defined in claim 2. This arrangement yields a compact display device. In a further embodiment in accordance with the invention, a parallelepiped is used as the light-guiding means. Adaptation of the shape of the parallelepiped allows a compact display system and a substantially perpendicular illumination of the reflective display device.

Another embodiment of the device in accordance with the invention is defined in claim 6. In this embodiment, the perpendicular illumination takes place by light-guiding means arranged between the optical system and the reflective display means. The light-guiding means may comprise a prism.

Further advantageous embodiments are defined in the dependent claims.

These and other aspects of the invention are apparent from and will be elucidated with reference to the embodiments described hereinafter.

In the drawing:

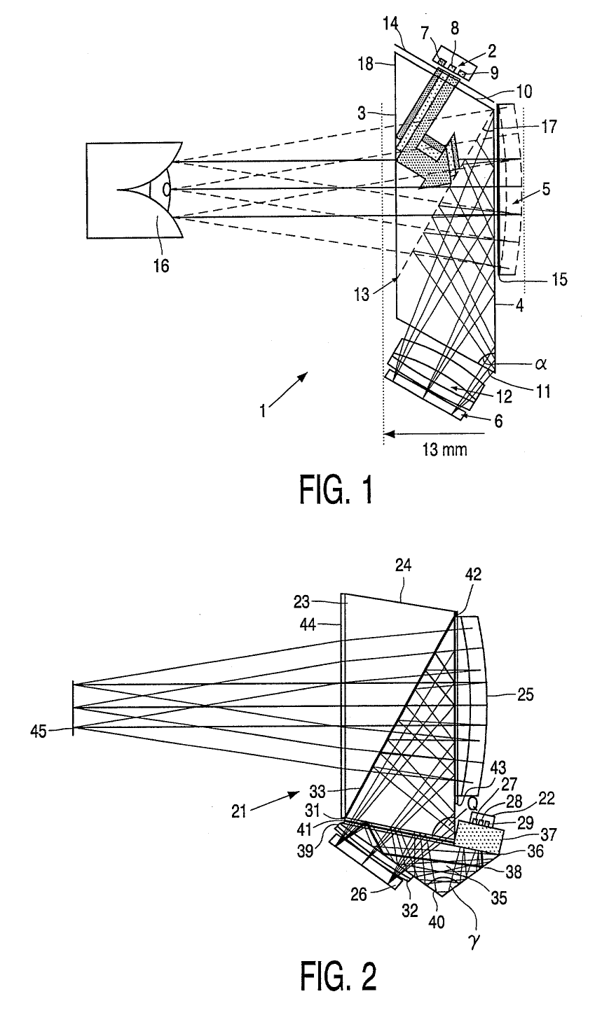

FIG. 1 shows an example of a first display device comprising a parallelepiped for illumination of the display panel and

FIG. 2 shows an example of a second display device comprising a TIR prism for illumination of the display panel.

FIG. 1 shows an example of a first display device wherein the illumination of the display device takes place by total internal reflection of light-guiding means. The first display device 1 comprises an illumination source 2 and an optical system 3 having a polarising beam-splitting (PBS) prism 4, a quarter-wave plate 15 and a concave mirror 5. Furthermore, the first display device 1 comprises a reflective display panel 6. The illumination source 2 comprises three LEDs 7, 8, 9 emitting red, green and blue radiation, respectively, for color-sequential illumination of the reflective display panel 6. The light-guiding means are provided between the LEDs 7, 8, 9 and the reflective display panel 6. In the first display device 1, the light-guiding means are formed by the polarising beam-splitting prism 4 which consists of a parallelepiped made of glass. The parallelepiped 4 comprises first and second pairs of parallel faces 10, 11; 17, 18 directed in the same direction, and a third pair of faces directed perpendicularly to the other two pairs of faces. The angle α between an entrance face 10 being one of the first pair of parallel faces 10, 11 and one of the second pair of parallel faces 17, 18 of the parallelepiped 4 is preferably 60°. This angle α can be adapted to reduce the depth of the first display device 1. This depth is defined by the distance between the faces 17, 18 of the second pair of the parallelepiped 4. The glass may be of a BK7 type. Preferably, the parallelepiped 4 is provided with a beam-splitting surface 13 arranged at an angle of 30° with respect to one of the faces of the second pair of parallel faces 17, 18 of the parallelepiped 4. The beam-splitting surface 13 consists of a wired grid polarizer as can be ordered from Moxtek Inc. Alternatively, a Double Brightness Enhancement Foil (DBEF) may be applied, which can be ordered from 3M. The LEDs 7, 8, 9 are mounted at the entrance face 10 of the parallelepiped 4. A polarizer 14 for improving the contrast of the image may be present between the LEDs 7, 8, 9 and the parallelepiped 4. Optionally, a diffuser (not shown) may be present for improving the light distribution on the reflective display panel 6. The reflective display panel 6 is mounted at the exit face 11 of the parallelepiped 4 parallel to the entrance face 10 of the parallelepiped 4. The first display device 6 comprises a reflective liquid crystal display panel, for example, a 0.47″ liquid crystal on silicon (LCOS) display panel. Preferably, a lens 12 is provided between the LCOS display panel 6 and the exit surface 11 of the parallelepiped 4 for reducing the field curvature and the image distortion of the formed image. The quarter-wave plate 15 is provided between the concave mirror 5 and one of the faces 17 of the second pair of faces of the parallelepiped 4 facing the concave mirror.

In operation, the red, green and blue LEDs 7, 8, 9 are activated sequentially during a period that is synchronised with the information of the respective red, green and blue image content that is sent sequentially to the LCOS display panel 6. The LEDs 7, 8, 9 radiate the red, green or blue radiation to the entrance face 15 of the parallelepiped 4 via the polarizer 14. The polarizer 14 transmits only a portion of the radiation having a polarisation in a first direction. The parallelepiped 4 transmits the radiation to the beam-splitting surface 13. The beam-splitting surface 13 transmits a portion of the radiation having a polarisation in the first direction to the LCOS display panel 6 via the lens 12. The LCOS display panel 6 rotates the polarisation direction of the red, green or blue radiation in accordance with the supplied image information and reflects the radiation back to the parallelepiped 4. The parallelepiped 4 transmits the radiation to the beam-splitting surface 13. The beam-splitting surface 13 reflects a portion of the radiation having a component of the polarisation in the second direction perpendicular to the first direction, towards the concave mirror 5 via the quarter-wave plate 15. The concave mirror 5 reflects the radiation back to the parallelepiped 4 via the quarter-wave plate 15 and forms a virtual image of the LCOS display panel 6. As the radiation has passed the quarter-wave plate 15 twice, the polarisation of the radiation is rotated in the first direction. In the parallelepiped 4, the polarising beam-splitting surface 13 transmits the radiation towards an eye 16 of a viewer. The viewer applying the first display device 1 will see a virtual image of the display at a distance of 2 meters and a viewing angle of 32°. This corresponds to viewing of a 1.3 meter diagonal screen at a distance of 3 meters or to viewing a 19″ monitor at a distance of 0.75 m. Adaptation of the angle α between the faces of the first pairs 10, 11 and second pairs 17, 18 of faces of the parallelepiped 4 and the total reflection inside the parallelepiped 4 allows a compact display device and provides a substantially perpendicular illumination of the reflective LCOS display panel 6. This substantially perpendicular illumination of the LCOS display panel 6 improves the contrast of the formed image.

FIG. 2 shows an example of a second display device. In the second display device 21, the light-guiding means are provided between the reflective display 26 and the optical system 23. The second display device 21 comprises an illumination source 22 and an optical system 23 comprising a parallelepiped 24, a quarter-wave plate 42 and a concave mirror 25. The parallelepiped 24 comprises first and second pairs of parallel faces 24, 31; 43, 44 directed in the same direction and a third pair of faces (not shown) directed perpendicularly to the other two pairs of faces. The angle α between an entrance face 31 being one of the first pair of parallel faces 24, 31 and one of the second pair of parallel faces 43, 44 of the parallelepiped 24 is preferably 80°. This angle α can be adapted to reduce the depth of the second display device 21. This depth is defined by the distance between the faces 43, 44 of the second pair of faces of the parallelepiped 24. The illumination source 22 comprises three LEDs 27, 28, 29 emitting red, green and blue radiation, respectively, for color-sequential illumination of the display screen 26. The light-guiding means is formed by the TIR prism 35. The TIR prism 35 consists of a triangular prism with an apex χ larger than 90° and a base 39. The TIR prism 35 is arranged between the reflective display panel 6 and the optical system so that the entrance face or base 39 of the TIR prism 35 faces the entrance face 31 of the parallelepiped 24 and an air gap is formed between these faces 31, 39. The LEDs 27, 28, 29 are mounted on a portion of the entrance face 39 of the TIR prism 35. Preferably, a polarizer 36 and a diffuser sheet 37 may be present between the LEDs 27, 28, 29 and the TIR prism 35. The reflective display panel 6, for example, an LCOS display panel of a similar type as applied in the first display device, is mounted at an exit face 40 of the TIR prism 35, which exit face is located between the entrance face 39 and the reflective display panel 6. Preferably, a lens 32 is provided between the LCOS display 26 and the TIR prism 35 for reducing the field curvature and the image distortion of the formed image. Furthermore, a reflective polarizer 41 is mounted between the entrance face 31 of the parallelepiped 24 and the base 39 of the TIR prism 35. The material of the parallelepiped 24 and the TIR prism 35 may be of a BK7 type glass. In general, a higher refractive index of the material of the parallelepiped 24 and the TIR prism 35 will yield a more compact system. In order to reduce chromatic aberration, the refractive index of the material of the lens 32 can be selected to be different from that of the material of the parallelepiped 24 and the TIR prism 35. The beam-splitting surface 33 and the reflective polarizer 41 may be a wired grid polarizer as can be ordered from Moxtek Inc. Alternatively, a Double Brightness Enhancement Foil (DBEF) may be applied, which can be ordered from 3M. Furthermore, a concave mirror is positioned adjacent one face of the second pair of faces of the parallelepiped 24 and a quarter-wave plate 42 is provided between the exit face 43 and the concave mirror 25.

In operation, the red, green and blue LEDs 27, 28, 29 are activated sequentially during a period that is synchronised with the information of the respective red, green and blue image content that is sent sequentially to the LCOS-display panel 26. The LEDs 27, 28, 29 alternately radiate the red, green or blue radiation to a portion of the entrance face 39 of the TIR prism 35 via the polarizer 36 and the diffuser 37. The polarizer 36 transmits only a portion of the radiation having a polarisation in a first direction. The side 38 of the TIR prism 35 not facing the LCOS-display panel 26 and between the exit face 40 and the base 39 of the TIR prism 35, reflects the radiation towards the reflective polarizer 41 at the entrance face 31 of the parallelepiped 24. The reflective polarizer 41 reflects the radiation having a component of polarisation in the first direction towards the LCOS display panel 26 via the TIR prism 35 and the lens 32. The LCOS display panel 26 rotates the polarisation direction of the red, green or blue radiation in accordance with the supplied image information and reflects the radiation back to the reflective polarizer 41 at the entrance face 31 of the parallelepiped 24 via the lens 32 and the TIR prism 35. The reflective polarizer 41 transmits the portion of the radiation having a component of the polarisation in the second direction perpendicular to the first direction, towards the parallelepiped 24. The beam-splitting surface 33 of the parallelepiped 24 reflects a portion of the radiation with a component of the polarisation in the first direction towards the concave mirror 25 via a quarter-wave plate 42. The concave mirror 25 reflects the radiation back to the parallelepiped 24 via the quarter-wave plate 42 and forms a virtual image of the LCOS display panel 26. As the radiation has passed quarter-wave plate 42 twice, the polarisation is rotated in the first direction. The beam-splitting surface 33 now transmits the radiation towards the eye 46 of a viewer. The viewer applying the second display device 21 will see a virtual image at a distance of 3 meters and a viewing angle of 35°. This corresponds to viewing a 19″ monitor at a distance of 0.75 meter. Adaptation of the angle α of the entrance face 31 and one of the other parallel sides 43, 44 of the parallelepiped 24 allows a more compact display device, and adaptation of the apex χ of the TIR prism 35 provides a substantially perpendicular illumination of the reflective LCOS display 26 via total reflection of the TIR prism 35. This perpendicular illumination of the LCOS display panel 26 improves the contrast of the formed image. As the entrance aperture of the optical system is at the base 39 of the TIR prism 35, all pixels of the LCOS display panel 26 are illuminated by the same face 38, providing a more homogeneous illumination as compared with the illumination of the first display device 1 shown in FIG. 1. Furthermore, the illumination in the second display device 21 is not at the eye side of the beam-splitting surface 33 so that, as compared with the first display device 1, the chance of disturbing reflections of the illumination system occuring in the formed image is reduced.

1. A display device comprising a reflective display means for forming an object source, a light source for illuminating the reflected display means, and an optical system for projecting a virtual image of the object source, characterized in that the display device comprises light-guiding means for substantially perpendicular illumination of the reflected display means via total reflection.

2. A display device as claimed in claim 1, characterized in that the optical system comprises a parallelepiped, a quarter-wave plate and a mirror.

3. A display device as claimed in claim 2, characterized in that the light-guiding means comprises the parallelepiped, in which the light source faces one of the faces of the parallelepiped and the reflective display panel is positioned adjacent to the opposite face of the one face of the parallelepiped.

4. A display device as claimed in claim 2, characterized in that the parallelepiped comprises a polarizing beam-splitting surface for transmitting a portion of the radiation having a first direction of polarization towards the reflective display means and for reflecting a portion of the radiation having a second direction of polarization reflected by the reflective display means towards the quarter-wave plate and the mirror, the second direction of polarization being perpendicular to the first direction, and for transmitting a portion of the reflected radiation having a polarization in the first direction from the quarter-wave plate and the mirror to a viewer.

5. A display device as claimed in claim 1, characterized in that the light-guiding means is positioned between the optical system and the reflective display means.

6. A display device as claimed in claim 5, characterized in that the display device is provided with a reflecting polarizing means between the light-guiding means and the optical system for reflecting radiation having a first direction of polarization from the light-guiding means towards the reflective display means and for transmitting a portion from the reflected radiation having a second direction of polarization perpendicular to the first direction from the reflective display means to the optical system.

7. A display device as claimed in claim 6, characterized in that the light-guiding means comprises a prism.

8. A display device as claimed in claim 7, characterized in that a portion of a side of the prism facing the entrance face of the optical system is optically coupled to the light source.

9. A display device as claimed in claim 8, characterized in that the optical system comprises a parallelepiped, a quarter-wave plate and a mirror.

10. A display device as claimed in claim 9, characterized in that the parallelepiped comprises a polarizing beam-splitting surface for reflecting a portion of the radiation having a polarization in the second direction coming from the reflective display means towards the mirror via the quarter-wave plate and for transmitting a portion of the reflective radiation having a polarization in the first direction from the quarter-wave plate and the mirror to a viewer.

11. A display device as claimed in any one of the preceding claims, characterized in that a further polarization means is positioned between the radiation source and the light-guiding means for transmitting radiation having a polarization in a first direction.

12. A display device as claimed in any one of the preceding claims, characterized in that the display device comprises a lens positioned between the reflective display means and the optical system.

13. A display device as claimed in any one of the preceding claims, characterized in that the display device comprises a reflective liquid crystal display or a digital micro-mirrored display.

14. A head mounted display provided with a display device as claimed in any one of the preceding claims.
